(19) United States
(12) Patent Application Publication
(10) Pub. No.: US 2026/0223833 A1
(43) Pub. Date: Aug. 6, 2026

(54) ANIMAL BARRIER FOR UTILITY POLE CABLE GUARD AND UTILITY POLE STRUCTURE HAVING AN ANIMAL BARRIER

(71) Applicant: Paul Keeler, Exton, PA (US)

(72) Inventor: Paul Keeler, Exton, PA (US)

(21) Appl. No.: 19/042,653

(22) Filed: Jan. 31, 2025

(51) Int. Cl. A01M 29/30; H02G 7/00

(52) U.S. Cl. CPC A01M 29/30; H02G 7/00

(57) ABSTRACT

A barrier for limiting entry of an animal into the interior of a cable-protecting conduit on a utility pole comprises a sheet of polymeric material adapted to be wrapped around the conduit and secured by fasteners to the utility pole. The sheet of polymeric material includes an undulating layer forming parallel flutes, and is formed with a plurality of separate, elongated, and resilient, finger-shaped parts extending from a portion of the sheet in the direction of elongation of the flutes. The finger-shaped parts are adapted to be bent downward so that they extend through an upper end opening of the cable-protecting conduit into the interior of the conduit to form a barrier.

### FIELD OF THE INVENTION

This invention relates to animal barriers for preventing squirrels and other animals from entry into a cable guard on a utility pole.

### BACKGROUND OF THE INVENTION

A utility pole is used for supporting electrical equipment such as transformers, power cables and/or other cables such as fiber-optic cables or cables for conducing electric current for other purposes such as communications or control. The utility pole will often have one or more cables extending from an upper portion of the pole downward along the exterior of the pole into a below-ground passage through which the cable or cables extend into a building or other structure. A protective cable guard, frequently referred to as a “riser,” is often provided along a lower portion of the utility pole to prevent damage to the cables by animals and accidental or intentional damage by human beings.

The protective cable guard serves as a conduit for one or more cables that extend vertically along a utility pole, and is typically either a vertically elongated metal cylinder surrounding the cable or cables and fastened to the utility pole by brackets or straps, or a vertically elongated metal cover having a U-shaped horizontal cross-section with flanges engaged with the pole and fastened to the pole by screws or other fasteners. These U-shaped metal covers are frequently referred to as “U-guards.” Some U-guards are provided with back plates that engage the pole and close off the gap between the flanges.

The cable guard will typically extend from ground level, from below ground level, or from an adapter adjacent the ground, to a height such that the cable or cables extending from the upper end of the conduit cannot be reached easily by a human being. Squirrels and other animals, however, can readily gain access to the opening through which the cable or cables extend at the upper end of the cable guard, and often enter the opening, build nests within the cable guard, and chew the cable insulation, causing damage requiring repairs.

Various closures have been devised to prevent access by animals to the interiors of these cable guards. An example is the hollow cover described in United States Patent No. 9,787,071, dated Oct. 10, 2017, which has a flexible lower opening for engagement with a portion of the cable guard below the upper end thereof, and a flexible upper opening for engagement with the cable or cables extending upward from the upper end of the cable guard. The cover described in Patent No. 9,787,071 is primarily for use with a cable guard in the form of a closed cylinder. Other closures, in the form of tapered caps, have been used with U-shaped cable guards. An example is the plastic “U-Guard Cap,” produced by Electrical Materials Company in Genoa City, Wisconsin.

The above-described closures are generally usable only with cable guards for which they are especially adapted. For example, a closure intended for use with a circular, cylindrical cable guard is usually configured to surround the cable guard and cannot ordinarily be used with a U-shaped cable guard. Similarly, a closure configured for use with a U-shaped cable guard, if used with a circular cylindrical cable guard, will leave gaps at locations adjacent the pole, each gap being defined by a portions of the pole, a portion of the cylindrical guard, and a portion of the closure.

Currently available closures are also usable only with cable guards in a very limited range of sizes.

The principal object of this invention is to provide an animal barrier for attachment at the upper end of a cable guard, which can be used with cable guards in a broad range of configurations and sizes. Another object of the invention is to provide an animal barrier which is simple, inexpensive, and easy to install, and which effectively deters squirrels and other creatures from entry into cable guards.

### SUMMARY OF THE INVENTION

One aspect of the invention can be described in terms of a utility pole structure comprising a utility pole, a protective conduit extending along a portion of the pole, cable means comprising one or more cables extending through the conduit, and a barrier for preventing entry of an animal into the protective conduit through an opening at the upper end of the conduit.

The barrier comprises a sheet of polymeric material secured to the utility pole on both sides of the protective conduit and extending around, and in contact with, a portion of the conduit adjacent the opening at its upper end. The sheet of polymeric material has a plurality of separate, elongated, and resilient, finger-shaped parts that extend downward into the interior of the protective conduit, and provide a partial closure that deters an animal from entry into the conduit through the opening at its upper end.

Preferably, the separate, elongated, finger-shaped parts extend upward along a portion of the exterior of the protective conduit adjacent the opening, and are bent over an edge of the opening and extend downward into the interior of the conduit.

In a preferred embodiment, an end portions of one or more of the finger-shaped parts is bent upward and in contact with the cable means without damage either to the cable or to the finger-shaped parts.

The protective conduit need not be a closed cylinder and can be shaped so that the cable means are surrounded by a structure comprising a combination of the protective conduit and a portion of a surface of the utility pole,

The protective conduit preferably comprises a part having a U-shaped horizontal cross-section with vertically extending edges and two flanges. Each flange extends outward from one of the vertical edges and is in contact with the utility pole, and secured to the utility pole by fasteners. In this case, the sheet of polymeric material preferably has opposite vertically extending edges, and portions adjacent its vertically extending edges secured to the utility pole adjacent the flanges of the protective conduit.

In an alternative embodiment, the structure surrounding the cable means comprises a cylindrical tube secured to the utility pole. Here, as in the embodiment having a flanged protective conduit, the sheet of polymeric material has opposite vertically extending edges, and portions adjacent the vertically extending edges engaged with the utility pole and secured to the utility pole by fasteners adjacent the vertically extending edges.

The sheet of polymeric material can be a flat, single layer, but preferably comprises first and second layers, the first layer having an undulating horizontal cross-section with peaks of its undulations secured to the second layer. The undulations of the first layer form flutes that extend in the direction of elongation of the finger-shaped parts.

The sheet of polymeric material preferably comprises an outer layer and at least one inner layer, the outer layer being composed of a material which protects the inner layer from damage resulting from ultraviolet radiation. A preferred material for the outer layer is a polyvinyl fluoride film. Various other materials, such as polyvinylidene fluoride films, and coatings of ultraviolet-resistant compositions, can also be used.

Whereas one aspect of the invention resides in the combination comprising the utility pole structure, the cable means, the protective conduit, and the sheet of polymeric material with fingers that form a barrier, the invention can also be defined in terms of a barrier. That is, the invention can be defined as a barrier for limiting entry of an animal into the interior of a protective conduit enclosing a portion of a cable means, where the barrier comprises a sheet of polymeric material having opposite side edges with portions adjacent the side edges adapted to be secured to a utility pole on both sides of a protective conduit, and an intermediate portion extending from one to the other of the portions adjacent the side edges and adapted to extend around, and contact, a portion of the protective conduit adjacent its upper end opening. The barrier has a plurality of separate, elongated, and resilient, finger-shaped parts extending from a portion of the sheet that connects the side edges. The finger-shaped parts are adapted to be bent downward so that they extend through the upper end opening into the interior of the protective conduit to form a barrier for preventing entry of animals into the protective conduit. Here, as in the case of the above-mentioned utility pole structure, the barrier preferably has the undulating cross-section and a protective layer for resisting deterioration resulting from ultraviolet radiation,

### BRIEF DESCRIPTION OF THE DRAWINGS

FIG. 1 is an elevational view of a barrier in accordance with the invention, showing the barrier in a flat condition.

FIG. 2 is a bottom plan view of the barrier of FIG. 1.

FIG. 3 is a cross-sectional view of one of the fingers of the barrier, taken on section plane 3-3 in FIG. 1.

FIG. 4 is an oblique perspective view showing the barrier secured to s utility pole on both sides of a U-shaped protective conduit, with fingers of the barrier bent over the upper end of the conduit.

FIG. 5 is an elevational view of the structure in FIG. 4.

FIG. 6 is a more detailed elevational view showing the barrier and portions of the protective conduit and utility pole in FIGS. 4 and 5.

FIG. 7 is a top plan view of a protective conduit and barrier on a utility pole, in which the fingers of the barrier extend obliquely downward.

FIG. 8 is a top plan view of a protective conduit and barrier on a utility pole, in which parts the fingers of the barrier are bent so that portions of the fingers extend obliquely downward into the conduit, and end portions of the fingers extend obliquely upward.

FIG. 9 is a top plan view of a protective conduit and barrier, in which the fingers of the barrier extend obliquely downward and in which ends of fingers are in contact with cables in a multiple-cable array extending vertically along the exterior of a utility pole.

FIG. 10 is a is a top plan view showing a barrier in accordance with the invention in cooperation with of a closed cylindrical protective conduit on a utility pole,

### DETAILED DESCRIPTION OF THE PREFERRED EMBODIMENTS

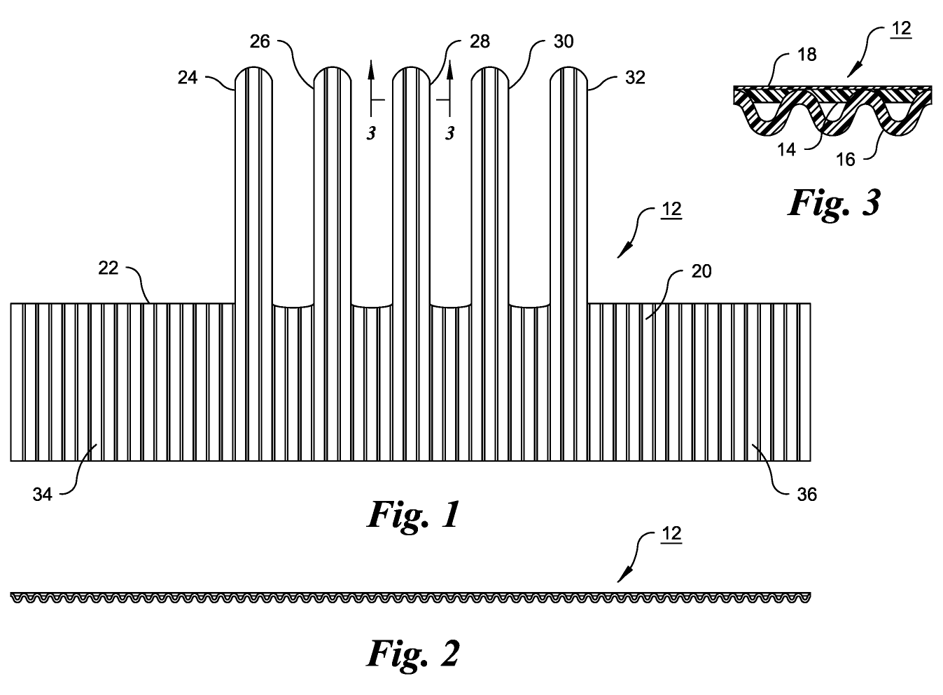

The barrier 12, as shown in FIGS. 1, 2 and 3, is preferably composed of three layers, one being a polymeric sheet 14, another being a polymeric sheet 16 having an undulating cross-section with undulations on one side of sheet 16 fitting into conforming depressions a face of sheet 14, and a third polymeric sheet 18 on the opposite face of sheet 14.

Sheets 14 and 16 can be composed of any of a variety of polymeric materials, and are preferably composed of polyethylene. Sheet 18, which will be on the external side of the barrier, i.e., the side that will be exposed to sunlight, is preferably a polyvinyl fluoride film that will protect the polyethylene layers from deterioration due to exposure to ultraviolet radiation. The three sheets, which are initially rectangular in shape, are fused together by the application of heat, and then cut to form an elongated rectangular body portion 20 and a plurality of finger portions extending perpendicularly from a long edge 22 of body portion 20, preferably in parallel relation and equally spaced from one another.

As shown in FIG. 1, fingers 24, 26, 28, 30 and 32 extend in parallel relation to one another from an intermediate portion of long edge 22 so that the fingers are positioned to be bent downward into a cable-protecting conduit while the outer portions 34 and 36 of the barrier are secured to a utility pole on opposite sides of the conduit.

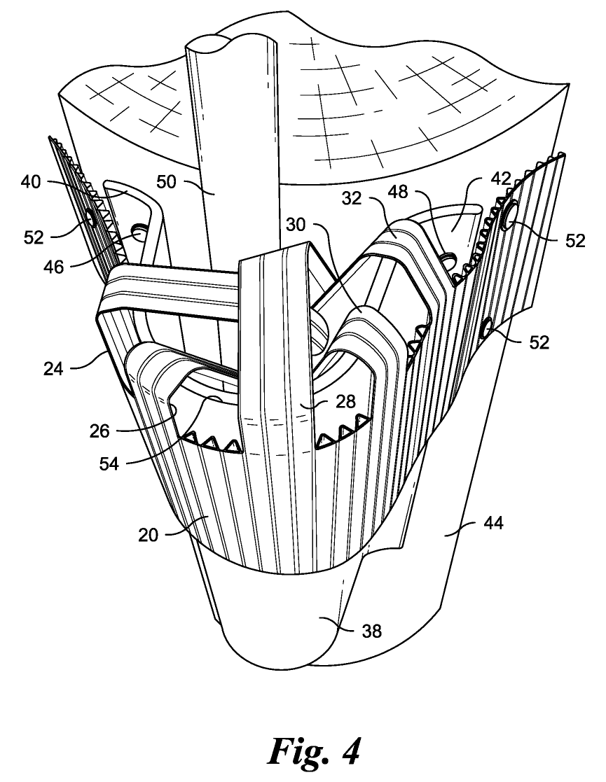

As shown in FIG. 4, a U-shaped cable-protecting conduit 38, having outwardly protruding flanges 40 and 42, is secured to a utility pole 44 by bolts 46 and 48 and other bolts not shown. A cable 50, e.g., an electric power cable, extends vertically through the conduit 38 and is preferably in contact with the pole 44, being secured to the pole 44 suitable means such as straps or clamps (not shown).

The end portions 34 and 36 of the barrier are secured to the utility pole by suitable fasteners such as nails 52 at locations adjacent the flanges 40 and 42, so that the body portion 20 of the barrier is held in contact with the outer surface of the conduit at least over an area remote from the flanges 40 and 42.

The fingers 24, 26, 38, 30, and 32 are bent so that each finger extends over the upper edge 54 of the conduit 38 and then downward into the interior of the conduit so that the fingers together form an obstacle preventing access by rodents and other animals to the interior of the conduit. After the end portions of the barrier are nailed to the utility pole the fingers are bent and pushed downward manually into the interior of the conduit. The pattern of the fingers in their final positions can be arbitrary, as shown in FIG. 4, but the cooperation of the bent fingers with the interior of the conduit and the cable will form an obstacle to the entry of animals into the interior of the conduit.

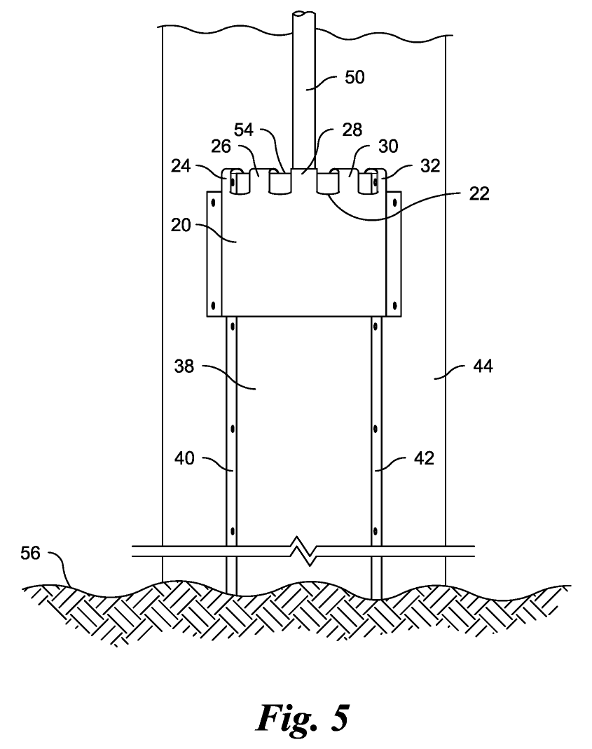

As shown in elevational view in FIG. 5, the conduit 38 extends upward from ground level 5, preferably to a height such that access to the cable 50 by a human being would require a special device such as ladder or an elongated tool. The cable itself extends into the protective conduit from underneath the ground level 56, and the conduit itself can also extend underneath the ground level, or can be connected to a suitable adapter that extends from below the ground level to a location at which it is connected to the conduit.

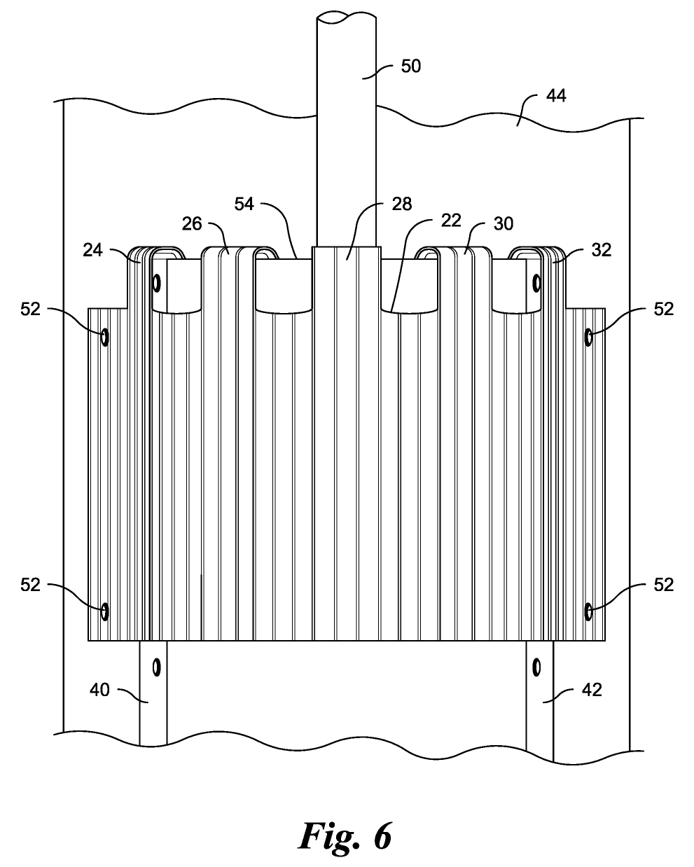

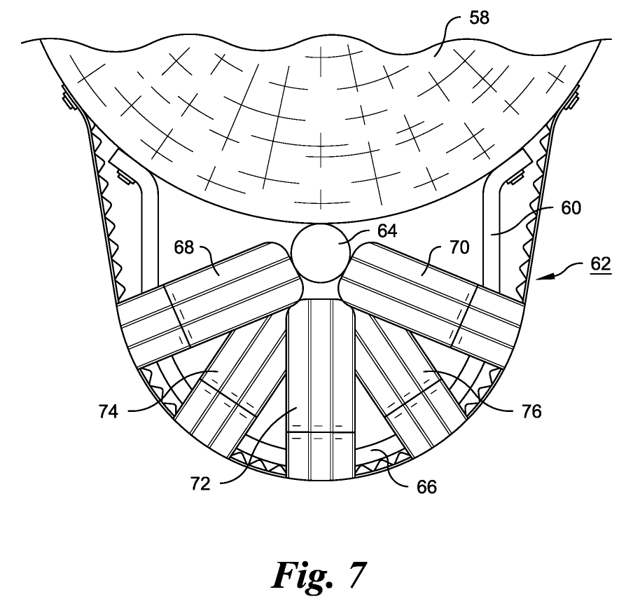

As shown in FIG. 6, the long edge 22 of the rectangular body portion 20 of the barrier is preferably located a short distance below the upper edge 54 of the conduit, and the fingers 24, 26, 28, 30 and 32 are bent so their bent portions extend over, and contact, the edge 54 of the conduit so that the portions of the fingers extending beyond the bent portions are located inside the conduit near the upper end thereof.

In FIG. 7, the utility pole 58, the protective conduit 60, the barrier 62, and the cable 64, are similar to the corresponding elements in FIGS. 4, 5 and 6. However the fingers of the barrier are arranged in a symmetrical pattern (in plan view). All of the fingers are bent downward over the upper edge 66 of the conduit 60, The tips of the outer fingers 68 and 70 contact the cable 64. The tip of the center finger 72 engages the undersides of fingers 68 and 70 and is thereby prevented from coming into contact with the cable 64. The tips of fingers 74 and 76 engage the underside of finger 72 and are likewise prevented from engaging the cable 64. The pattern of the fingers, nevertheless, is such that they cooperate to form an obstacle to the entry of animals into the interior of the conduit. Other arrangements of the fingers can be utilized. For example, the tips of fingers 74 and 76 can touch cable 64, and fingers 68, 70 and 72 can be below fingers 74 and 76. In other embodiments, the tips of one or more of the fingers can touch the utility pole 58.

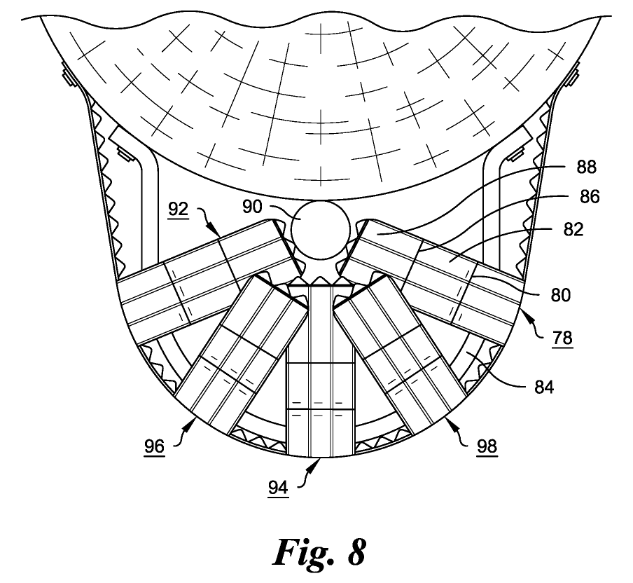

In the version shown in FIG. 8, the fingers are bent so that portions of the fingers extend obliquely downward into the conduit, and end portions of the fingers extend obliquely upward. For example, finger 78 is bent at a bend location 80 so that a portion 82 of the finger extends downward into the interior of the conduit 84, and is bent again at bend location 86 so that an end portion 88 of the finger extends upward and the tip of the finger engages the cable 90. Finger 92 is bent in a similar manner, and its tip engages cable 90. The central finger 94 is also bent so that it has downward and upward portions similar to fingers 79 and 92. However, its tip engages portions of fingers 78 and 92 adjacent the cable, and does not touch the cable. Fingers 96 and 98 ae bent in a similar manner, and their tips engage the upwardly extending portion of finger 94 and do not touch he cable. Here again, the fingers are disposed in a pattern such that they form an obstacle to the entry of animals into the interior of the conduit.

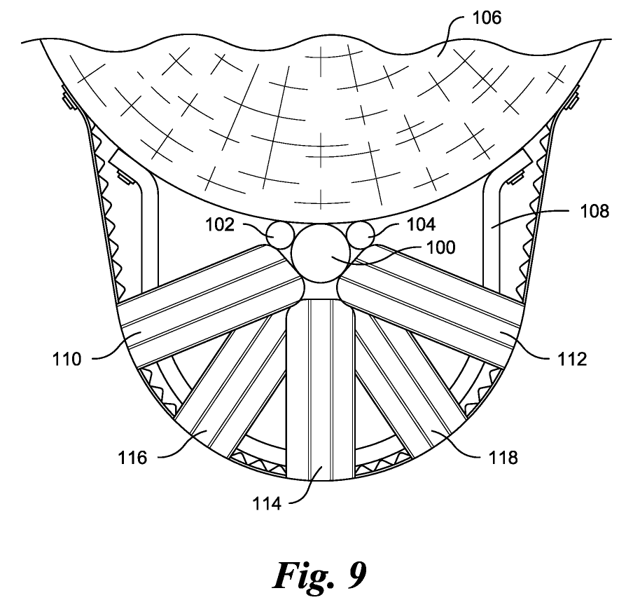

In FIG. 9, an array of cables 100, 102 and 104 extends vertically along the surface of a utility pole 106 inside a U-shaped conduit 108, The tips of the outermost fingers 110 and 112 engage the cables. The tip of the central finger 114 engages the undersides of fingers 110 and 112, and the tips of fingers 116 and 118 engage the underside of finger 114. Here, as in FIG. 7, other arrangements of the fingers can be utilized.

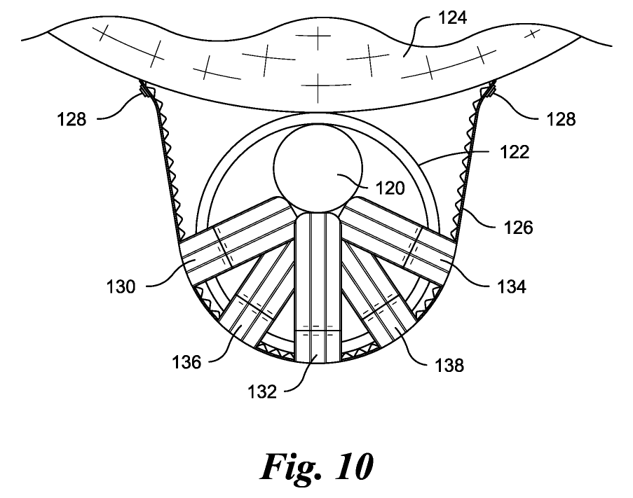

In FIG. 10, a cable 120 is inside a conduit 122 which is a closed cylinder. The conduit is fastened to a utility pole 124 by clamps or straps (not shown). The rectangular body portion 126 of a barrier, which can be identical to barrier 12 in FIG. 1, is secured to the utility pole by nails 128 and extends around the outside of the conduit 122, and is in contact with a portion of the exterior of the conduit. The fingers of the barrier are bent downward over the upper edge of the conduit and are shown in a configuration in which the tips of fingers 130, 132 and 134 contact the cable 120, and the tips of fingers 136 and 138 extend underneath portions of finger 130 and 134 respectively, The tips of fingers 136 and 138 can, but do not necessarily, touch cable 130.

Various modifications to the several embodiments of the invention as described above can be made. For example, the barrier can have more, or fewer, than five fingers, and the fingers on a barrier can be shaped differently from one another. These and other modifications can be made to the barrier described above without departing from the scope of the invention as defined in the following claims.

What is claimed is:

1. A utility pole structure having a cable guard, said structure comprising:
a utility pole extending upward from a surface;
cable means, comprising at least one cable, said cable means extending lengthwise along said utility pole from an upper portion thereof to a location below said surface;
a protective conduit extending upward along a portion of said utility pole from a location adjacent said surface to an inteediate location between said surface and said upper portion of said utility pole, a portion of said cable means extending from said location adjacent said surface to said inteediate location being surrounded by a surrounding structure comprising said protective conduit, said protective conduit having an opening at said inteediate location through which said cable means extends; and
a sheet of polymeric material secured to said utility pole on both sides of said protective conduit and extending around, and in contact with, a portion of said protective conduit adjacent said opening thereof, said barrier having a plurality of separate, elongated, and resilient, finger-shaped parts extending downward into the interior of said protective conduit, said finger- shaped parts forming a barrier for preventing entry of
an animal through said opening into the interior of said protective conduit.

2. The utility pole structure according to claim 1, in which said separate, elongated, finger-shaped parts extend upward along a portion of the exterior of said protective conduit adjacent said opening thereof, and are bent over an edge of said opening and extend downward into the interior of said protective conduit.

3. The utility pole structure according to claim 1, in which said separate, elongated, finger-shaped parts extend upward along a portion of the exterior of said protective conduit adjacent said opening thereof, and are bent over an edge of said opening and extend downward into the interior of said protective conduit, with an end portions of at least one of said finger-shaped parts being bent upward and in contact with said cable means.

4. The utility pole structure according to claim 1, in which said surrounding structure comprises a combination of said protective conduit and a portion of a surface of said utility pole.

5. The utility pole structure according to claim 1, in which said surrounding structure comprises a combination of said protective conduit and a portion of a surface of said utility pole, in which said protective conduit comprises a
part having a U-shaped horizontal cross-section with vertically extending edges and two flanges, each extending outward from one of said vertical edges and in contact with said utility pole, and fasteners securing said flanges to said utility pole, in which said sheet of polymeric material has opposite vertically extending edges, and portions adjacent said vertically extending edges, said portions being secured to said utility pole adjacent said flanges.

6. The utility pole structure according to claim 1, in which said surrounding structure comprises a cylindrical tube secured to said utility pole and in which said sheet of polymeric material has opposite vertically extending edges, and portions adjacent said vertically extending edges, said portions being engaged with said utility pole, and fasteners securing said portions adjacent said vertically extending edges to said utility pole.

7. The utility pole structure according to claim 1, in which said sheet of polymeric material comprises first and second layers, the first layer having an undulating horizontal cross-section with peaks of its undulations secured to said second layer, the undulations of said first layer foing flutes that extend in the direction of elongation of said finger-shaped parts.

8. The utility pole structure according to claim 1, in which said sheet of polymeric material comprises an outer
layer and at least one inner layer, said outer layer being composed of a material that protects said at least one inner layer from damage resulting from ultraviolet radiation.

9. The utility pole structure according to claim 1, in which said sheet of polymeric material comprises an outer layer and at least one inner layer, said outer layer being composed of a film of polyvinyl fluoride that protects said at least one inner layer from damage resulting from ultraviolet radiation.

10. The utility pole structure according to claim 1, in which said sheet of polymeric material comprises first, second, and third layers, the first layer having an undulating horizontal cross-section with peaks of its undulations secured to said second layer, the undulations of said first layer foing flutes on one side of said second layer that extend in the direction of elongation of said finger-shaped parts, and said third layer being secured to a surface of said second layer opposite said one side thereof and being composed of a material that protects said at second layer from damage resulting from ultraviolet radiation.

11. The utility pole structure according to claim 1, in which said sheet of polymeric material comprises first, second, and third layers, the first layer having an undulating horizontal cross-section with peaks of its undulations secured to said second layer, the undulations of
said first layer foing flutes on one side of said second layer that extend in the direction of elongation of said finger-shaped parts, and said third layer being secured to a surface of said second layer opposite said one side thereof and being composed of polyvinyl fluoride.

12. A barrier for limiting entry of an animal into the interior of a protective conduit enclosing a portion of a cable means comprising at least one cable, said protective conduit extending along a utility pole and having an upper end opening through which said cable means extends, said barrier comprising a sheet of polymeric material having opposite side edges with portions adjacent said side edges adapted to be secured to a utility pole on both sides of said protective conduit, and an inteediate portion extending from one to the other of said portions adjacent said side edges and adapted to extend around, and contact, a portion of said protective conduit adjacent said upper end opening thereof, said barrier having a plurality of separate, elongated, and resilient, finger-shaped parts extending from a portion of said sheet that connects said side edges, said finger-shaped parts being adapted to be bent downward so that they extend through said upper end opening into the interior of said protective conduit to foa barrier for preventing entry of animals into said protective conduit.

13. The barrier according to claim 12, in which said sheet of polymeric material comprises first and second
layers, the first layer having an undulating cross-section with peaks of its undulations secured to said second layer, the undulations of said first layer foing flutes that extend in the direction of elongation of said finger-shaped parts.

14. The barrier according to claim 12, in which said sheet of polymeric material comprises an outer layer and at least one inner layer, said outer layer being composed of a material that protects said at least one inner layer from damage resulting from ultraviolet radiation.

15. The barrier according to claim 12, in which said sheet of polymeric material comprises an outer layer and at least one inner layer, said outer layer being composed of a film of polyvinyl fluoride that protects said at least one inner layer from damage resulting from ultraviolet radiation.

16. The barrier according to claim 12, in which said sheet of polymeric material comprises first, second, and third layers, the first layer having an undulating cross- section with peaks of its undulations secured to said second layer, the undulations of said first layer foing flutes on one side of said second layer that extend in the direction of elongation of said finger-shaped parts, and said third layer being secured to a surface of said second layer opposite said one side thereof and being composed of a material that protects said second layer from damage resulting from
ultraviolet radiation.

17. The barrier according to claim 12, in which said sheet of polymeric material comprises first, second, and third layers, the first layer having an undulating cross- section with peaks of its undulations secured to said second layer, the undulations of said first layer foing flutes on one side of said second layer that extend in the direction of elongation of said finger-shaped parts, and said third layer being secured to a surface of said second layer opposite said one side thereof and being composed of polyvinyl fluoride.
